(19) United States
(12) Patent Application Publication
(10) Pub. No.: US 2022/0312172 A1
(43) Pub. Date: Sep. 29, 2022

(54) NOVEL EMERGENCY-EVENT MONITOR AND CAPTURE SYSTEM

(71) Applicant: Lonnie Donnell Wright, SR., Mansfield, TX (US)

(72) Inventor: Lonnie Donnell Wright, SR., Mansfield, TX (US)

(21) Appl. No.: 17/699,252

(22) Filed: Mar. 21, 2022

Related U.S. Application Data
(60) Provisional application No. 63/207,824, filed on Mar. 25, 2021.

(51) Int. Cl. H04W 4/90; H04W 4/029; G06V 20/40; G06V 20/52; G06F 3/16

(52) U.S. Cl. CPC H04W 4/90; H04W 4/029; G06V 20/48; G06V 20/44; G06V 20/52; G06F 3/16; G06V 20/17

(57) ABSTRACT

An emergency reporting network system includes a server node that collects and records a variety of information about an emergency event from a data-capture node, such as a microphone and camera equipped mobile phone, tablet, or laptop computer. The data-capture node may initiate a report through an application installed on the device. The server node may collect location, audio, video, and other information related to the event. The server may use the information to compare with information from other reports in order to correlate reports to events. The server may collect information from other data-capture nodes (e.g., camera drones, mounted security camera, bodycams) in the vicinity of the reporting node. A notification of an event, and information collected regarding the event, may be shared with a central authority (e.g., police, security) or with other nodes in the network (e.g., a list of contacts associated with the reporting node, security personnel).

### CROSS-REFERENCE TO RELATED APPLICATIONS

This application claims the benefit of U.S. Provisional Application No. 63/207,824, filed on Mar. 25, 2021.

### BACKGROUND AND SUMMARY

This invention pertains generally to technology for monitoring and capturing an emergency event that improves over the over the prior-art emergency-reporting systems such as the 911 system. More specifically, the invention is directed to technology by which a witness to an emergency event such as an accident, a fire, police intervention with a citizen, or a riot may initiate a process by which the existence of the event is reported to a server and/or authority. Location (e.g., GPS or cell-tower) information is reported and recorded, and video and audio information is acquired, reported, and recorded.

The technology enables, for example, an authority (e.g., police or other first responder, community organization, facility security, military) to assess an event through real-time user-provided information. This in turn enables the authority to assess the event before responding or arriving on the scene or to adapt to an evolving event while on the scene.

The technology allows the authority to collect and correlate information about a single event from multiple viewpoints or eyewitnesses. With such information, the authority can better respond to the event in real-time or to better reconstruct the event for training, prevention, and adjudication purposes.

In an aspect of the invention, a method for receiving a record of an emergency event includes using a network including at least one data-capture node (e.g., camera-equipped phone or tablet) and at least one server node (which may be implemented as a centralized, decentralized, or distributed system). The node may be connected through any of a myriad of network-communication systems, for example: the Internet, cellular networks, local area networks, or combinations thereof. The server node receives an indication of the existence of an emergency event from a data-capture node. For example, a person may witness an event such as an assault or carjacking. The person may send a notice to the server through a mobile device such as a phone or tablet by using an app installed on the device. The server receives the notification and in response accesses video, audio, and location information from the data-capture node. For example, the app on the witnesses device may send: GPS, GLONASS, cell-tower, or other location information; visual information from the device camera (still or moving, collectively “video” herein); and audio information from the device microphone. The server stores at least a portion of this information (e.g., in a local or other data store).

The server node may receive another indication about an event from a different data-capture node, access location, audio, or video data on this second data-capture node and compare information from the second data-capture node with information from the first data-capture node. From this, the server may, for example, determine whether the second data-capture node is reporting the same event as the first data-capture node.

The server node may use location information from a reporting data-capture node to identify additional data-capture nodes that may be used to capture information about the event. The server then may access information from the identified additional data-capture nodes. For example, the server may identify a camera-equipped drone in the vicinity of the reporting data-capture node and access the video data from the drone.

In some implementations, the server node may request control of the camera of the reporting data-capture node. In other implementations, the server may be preauthorized to take control of the camera. In other implementations, a user (person) may control the upload of the video information from the data-capture node to the server node.

The server node may send some or all of the information it receives from the data-capture node to an authority node. An authority node is a node associated with some organization with authority over the locale or type of event being reported. For example: an emergency event involving a fire may invoke one or more fire departments or stations; an emergency event involving a crime may invoke one or more police departments or stations; and an emergency event in the parking lot of a football stadium may invoke the security for that venue. The server may share the information with multiple authorities.

The server node may send an indication of the reporting of the event to one or more communication nodes associated with the reporting data-capture node. For example, a mobile phone or tablet reporting the emergency event may be associated with a list of phone numbers, email addresses, IP and/or other contact addresses to which a notification is to be sent if the reporting node reports an emergency event. This indication may consist of or include location, audio, or video information from the reporting node. The indication may also be distinct from the location, audio, or video information from the reporting node. For example, the server may send a simple message such as: “<NAME> has reported an emergency event” where <NAME> is a name associated with the reporting node. (Other identifiers may be used, such as the address or telephone number of the reporting node.)

In an aspect of the invention, a network for capturing records of emergency events includes a server node that is configured to: (1) connect with a data-capture node, (2) receive an indication of an emergency event from the connected data-capture node, (3) access audio, video, and location information from the connected data-capture node, and (4) store at least a portion of the accessed information. The server may be configured through use of general-purpose processors or logic devices or application-specific processors, logic devices, or circuits that are programmed or otherwise structured to perform this algorithm (alone or in combination). The algorithm of the server node may include identifying one or more additional data-capture nodes and accessing information from one or more of the identified additional data-capture nodes. The algorithm of the server node may include identifying one or more communication nodes and transmitting audio, video, or location data from the data-capture node to one or more of the identified communication nodes.

The network may further include an authority node that is configured to: (1) receive an indication of an emergency event from the server node, and (2) receive, from the server node, audio, video, or location data that is accessed from the data-capture node. In this implementation, the algorithm of the server node would include the steps of: (1) connecting with the authority node, (2) transmitting an emergency-event indication to the authority node, and (3) transmitting, to the authority node, audio, video, or location data that is accessed from the data-capture node. The algorithm of the authority node may include requesting from the server node information from one or more additional data-capture nodes. The algorithm of the authority node may include identifying one or more additional data-capture nodes and accessing information from one or more of the identified additional data-capture nodes. The algorithm of the authority node may include identifying one or more communication nodes and transmitting audio, video, or location data from the data-capture node to one or more of the identified communication nodes.

### BRIEF DESCRIPTION OF THE DRAWINGS

These and other features, aspects, and advantages of the present invention will become better understood with reference to the following description, appended claims, and accompanying drawings where:

FIG. 1 depicts an exemplary network environment which supports an implementation of the invention.

FIG. 2 is a flow chart depicting an exemplary process for receiving an emergency-event report.

FIG. 3 is a flow chart depicting an exemplary process for reporting an emergency-event.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

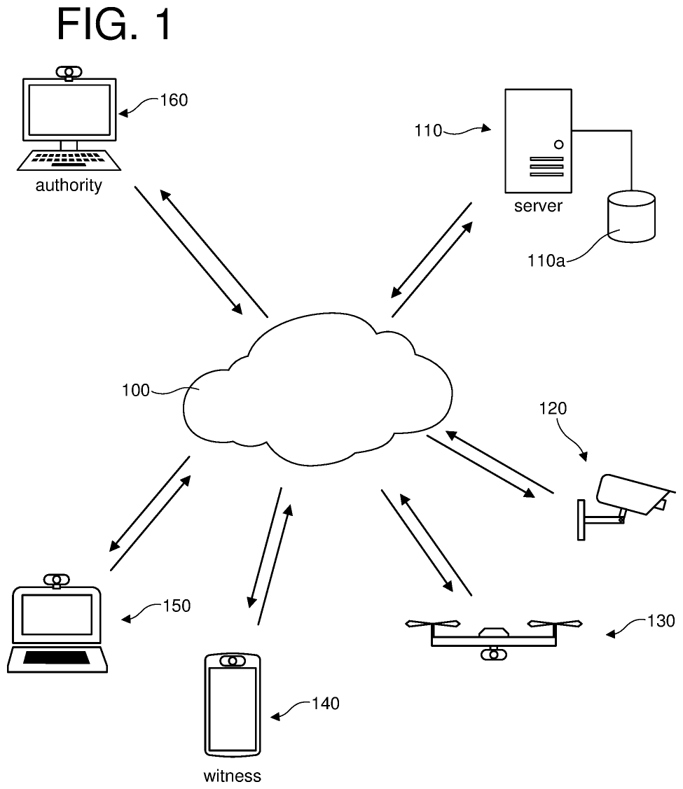

An exemplary network environment suitable for operation of an emergency-event system according to an aspect of the invention is illustrated in FIG. 1. A communication network 100 (e.g., Internet, WAN, LAN, cellular system) enables communication between one or more of a variety of video or audio enabled devices 120, 130, 140, 150 (the “data-capture nodes”) to a central-authority device 160 (the “authority node”) and a data/application server 110 (the “server node”). (In the figure, the authority device 160 and server 110 are depicted as distinct components, but they may be implemented in a single system or each/together implemented in a distributed system.)

In operation a user witnessing an emergency event can initiate communication with the authority 160 via an application installed on a mobile device 140 (e.g., a mobile phone, laptop computer, tablet) or other data-capture node. Once communication is established, information from the data-capture node 140 is shared with the authority 160 to assess the event. For example, location data (e.g., GPS) from the data-capture node 140 may be accessed by the authority 160 to determine the location (at least approximately) of the event. The authority 160 may access video or audio data collected by the data-capture node 140 in order to monitor, assess, or record the event. For example, the user may provide an eye-witness report via audio collected by the data-capture node 140 while simultaneously providing video of the event-in-process that is also collected by the data-capture node 140. The authority 160 may save this data, along with forensic/verification information such as time stamps, device addresses, user identification, location stamps, and authority-personnel identification, to a data store (e.g., a hard drive or cloud storage). In some implementations, communication between the data-capture node 140 and the authority 160 includes a data/application server 110 having a data store 110a. All or some of the information shared between the data-capture node 140 and the authority 160 may be automatically archived in the data store 110a.

The authority 160 may receive information from multiple devices for the same event. For example, an application on a second witness data-capture node 150 may be used to initiate communication with authority 160 to share information about the event independent of the first data-capture node 140. Such a scenario could represent two independent witnesses observing the same event from different viewpoints. The authority 160 or the data/application server 110 may correlate the event reported through the first data-capture node 140 with the event reported through the second data-capture node 150 using information provided by the data-capture nodes 140, 150. The correlation may be indicated to, or recorded by, central-authority personnel through, e.g., a text or graphic display on the authority device 160. For example, location data from the data-capture nodes 140, 150 may indicate that the two nodes 140, 150 are sharing information from a single event. In another example, image interpretation techniques may be used to identify the type of events being reported, and the correlation may include comparing the types. For instance, image interpretation may indicate that video information shared by the data-capture nodes 140, 150 indicates a building fire for both events. This, along with, e.g., time and location information, may be used to infer the devices 140, 150 are reporting the same event. Similarly, facial-recognition or like image interpretation may be used to denote one or more people in the video information from the first device 140 and one or more people in the video information from the second device 150 and to then compare the denoted people. A similarity in one or more of the denoted people may be used to infer the devices 140, 150 are reporting the same event.

The authority 160 or the data/application server 110 may request information from other devices based on the event information received. For example, the authority 160 may use location information from the event-reporting data-capture node 140 to identify and access one or more security cameras 120 in the same approximate location. Similarly, the authority 160 may use the event information to access or deploy one or more camera-equipped drones 130 or security vehicles or personnel. In this way, more information about the event than is provided through the reporting data-capture node 140 alone may be accessed and stored.

The authority 160 or the data/application server 110 may share the real-time event information from one or more of the devices 120, 130, 140, 150 with other devices. For example, the authority 160 may represent a facility such as a football stadium or school and the event may pertain to a criminal or terrorist act being perpetrated in the stadium/school or parking lot of the stadium/school. A witness to the act may communicate the act to the authority 160 via the user's device 140 (as described above) and the authority 160 (or the server 110) may share this information in real time with a police department or government agency. Similarly, the event information may be shared in real-time with personnel that are dispatched to address the event. The information shared, with whom it is shared, when it was shared, and other details of the sharing may be recorded by the authority 160 or server 110.

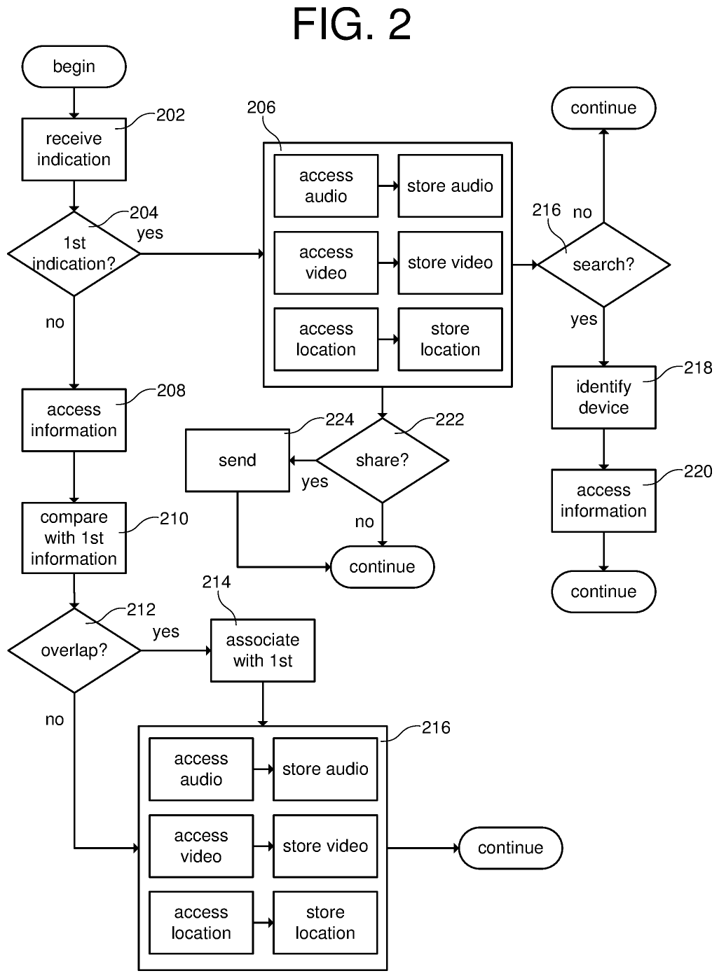

An exemplary process for receiving an emergency-event report is illustrated in FIG. 2. A system (e.g., an authority node 160 or data/application server 110) receives an indication of an emergency event 202. For example, the system may receive an indication sent by a first witness through an application on the first witness's device. The system will determine if this is the first indication by, for example, looking at the relevant period of time for some relevant geography 204 associated with the indication or by identifying the device sending the indication. If it is the first indication, the system will access and store information from the first witness device 206. If it is not the first indication (e.g., it is from a different device than sent the first indication), the system will access information from the device associated with subsequent indication 208 and compare it with information associated with the first indication of the event 210. For example, a first indication may be sent by a first device and a second indication may be sent from a second device. Location data from the second device may be compared with location data from the first device to determine if the locations are within the same vicinity (e.g., within 500 yards of each other). Other comparisons may be performed, such as biometric or other person-identifying analyses of video or audio data or image analysis to determine the event type. A determination is made whether there is sufficient overlap in information between the two indications that they may be associated with a the same event 212. If there is sufficient overlap, an association between the first indication and the subsequent indication is noted 214 and information from the device sending the subsequent indication is accessed and stored 216. If there is not sufficient overlap, the information from the device sending the subsequent indication is accessed and stored 216 without noting an association and the information associated with the subsequent indication maybe processed similarly to how the information associated with the first indication is processed (as described herein).

The system may use the information accessed from the device sending the first indication to identify other information-collecting devices that it may use to access information about the event. For example, the system may determine whether to search for such ancillary or auxiliary devices 216 and, if so, identify such devices based on location information from the device sending the first event indication 218. Then it will access information from the identified ancillary/auxiliary device(s) 220. For example, based on the location data, the system may identify a building-mounted security camera in the vicinity and access video (and potentially audio) information from the security camera. In this way, the system may acquire essential or supplemental information about the event.

The system may determine whether to share the information from the indication-sending device with other systems 222. If so, it can send some or all of the event-related information to the other system 224. For example, the system may determine based on the identity of the indication-sending device to share the accessed information with a predetermined list of other devices. One such scenario could be a data-capture node that is registered with the system as associated with one or more communication devices that are to be notified on any indication of an emergency event (e.g., a list of friends or contacts). The system may stream, in real-time, the event information accessed from the data-capture node to the communication device(s) (which may or may not also qualify as data-capture nodes). In another exemplary scenario, the system may use the approximate location of the event to determine whether to share the information with an authority in the vicinity of the event, such as a police department, fire department, or emergency medical services.

In another exemplary implementation of an emergency-event system according to an aspect of the invention, the authority 160 is not necessarily present. In such an implementation, the server 110 coordinates the event processing: it receives and records the indication of the emergency event from a data-capture node (e.g., mobile device 140), it collects video or audio information from the indicating node, it may request and receive information from other data-capture nodes (e.g., camera 120, drone 130), and it may receive one or more other indications from other nodes (e.g., mobile device 150) and determine whether any of the other indications refer to the original emergency event. The server 110 may notify (e.g., through telephone call, text message, email, or app notification) one or more communication devices (e.g., communication-enabled phone, tablet, computer, etc.; collectively, “communication nodes”) that are associated with the reporting data-capture node. This notification may include notice of the indication of the emergency event along with information about the event (e.g., the originating data-capture node identifier such as a user name or device number, the approximate location of the event, the time the indication was sent or received, a video or audio stream captured by the capture-node 140). For example, a mobile-device 140 user may be approached by individuals claiming to be or represent the police or a government agency. The user may initiate communication with the application server 110 through an app on the user's data-capture node 140 and the server in turn notifies those in the user's to-notify list. Optionally, the server 110 may also notify an authority (e.g., the police or the government agency) and establish a communication link between the user's device 140 and the authority.

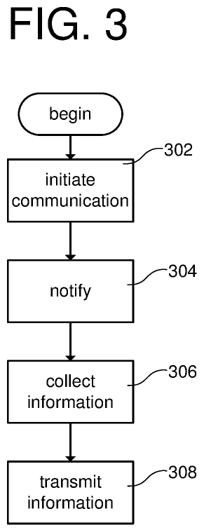

An exemplary process for reporting an emergency event is illustrated in FIG. 3. On witnessing an emergency event, the witness initiates communication between a data-capture node and a server node 302. For example, the witness may open a communication channel through an application on a camera-equipped mobile device, tablet, or computer. The data-capture node then provides a notification of the emergency event 304. Location data may be sent with the notification, or it may be sent in a subsequent step (or both). The data-capture node then collects information regarding the event 306. For example, the camera may collect audio and video information of the event. This could be at the control of the witness, in which case the data-capture node will be used to actively collect the information. Alternatively, the server node may take control over the camera and microphone to collect the information, perhaps providing instructions to the witness regarding positioning of the data-capture node. The data-capture node then transmits some or all of the collected information 308. For example, the audio and video data collected by the data-capture node may be stored on the data-capture node and then transmitted to the server or it may be streamed directly to the server. The transmission may be in response to a request from the server, under control of the server, or on the initiative of the data-capture node.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. An emergency-event-record-receiving method in a network comprising at least one data-capture node and at least one server node, the method comprising:
(a) receiving, at a server node, a first indication of a first emergency event from a first data-capture node;
(b) in response to receiving the first indication:
(i) accessing audio information from the first data-capture node;
(ii) accessing video information from the first data-capture node; and
(iii) accessing location data from the first data-capture node;
(c) storing at least a portion of the audio information accessed from the first data-capture node;
(d) storing at least a portion of the video information accessed from the first data-capture node; and
(e) storing at least a portion of the location information accessed from the first data-capture node.

2. The method of claim 1 further comprising:
(a) receiving, at the server node, a second indication of a second emergency event from a second data-capture node;
(b) in response to receiving the second indication, accessing second-data-capture-node information including at least one of the group consisting of audio information from the second data-capture node, video information from the data-capture node, and location information from the second data-capture node; and
(c) comparing the accessed second-data-capture-node information with one or more of the audio information accessed from the first data-capture node, video information accessed from the first data-capture node, and location information accessed from the first data-capture node.

3. The method of claim 2 further comprising: determining, based on the comparing step, whether the first emergency event and the second emergency event are the same event.

4. The method of claim 1 further comprising:
(a) identifying one or more additional data-capture nodes based on location information accessed from the first data-capture node; and
(b) accessing information from the one or more identified additional data-capture nodes.

5. The method of claim 4 wherein one of the one or more identified additional data-capture nodes is one of the group consisting of a camera-equipped drone, a building-mounted security camera, a dashcam, a bodycam, and a traffic camera.

6. The method of claim 1 wherein the accessing video information includes a server node requesting control of a camera associated with the first data-capture node.

7. The method of claim 1 wherein the accessing the video information includes receiving a stream of video information collected by a camera associated with the first data-capture node.

8. The method of claim 1 further comprising sending, to an authority node, at least a portion of one or more of the audio information accessed from the first data-capture node, video information accessed from the first data-capture node, and location information accessed from the first data-capture node.

9. The method of claim 1 further comprising sending, to a communication node, at least a portion of one or more of the audio information accessed from the first data-capture node, video information accessed from the first data-capture node, and location information accessed from the first data-capture node.

10. The method of claim 1 further comprising sending, to a communication node, a notification of receiving the first indication.

11. An emergency-event-record-capture network comprising:
(a) a server node configured to perform the following algorithm:
(i) connect with a first data-capture node;
(ii) receive, from the first data-capture node, an indication of an emergency event;
(iii) access audio, video, and location data from the first data-capture node;
(iv) store at least a portion of the audio, video, and location data accessed from the first data-capture node.

12. The network of claim 11 further comprising an authority node, wherein:
(a) the algorithm the server node is configured to perform further includes:
(i) connect with the authority node;
(ii) transmit, to the authority node, an indication of the emergency event; and
(iii) transmit, to the authority node, at least a portion of one or more of the group consisting of audio, video, and location data accessed from the first data-capture node; and
(b) the authority node is configured to perform the following algorithm:
(i) receive, from the server node, an indication of the emergency event; and
(ii) receive, from the server node, at least a portion of one or more of the group consisting of audio, video, and location data accessed from the first data-capture node.

13. The network of claim 12 wherein the algorithm the authority node is configured to perform further includes:
(a) request, from the server node, at least one of the group consisting of audio data from an additional data-capture node and video data from an additional data-capture node.

14. The network of claim 12 wherein the algorithm the authority node is configured to perform further includes:
(a) identify an additional data-capture node; and
(b) access at least one of the group consisting of audio data from the additional data-capture node and video data from the additional data-capture node.

15. The network of claim 12 wherein the algorithm the authority node is configured to perform further includes:
(a) identify a communication node; and
(b) transmit, to the communication node, at least a portion of one or more of the group consisting of audio, video, and location data from the first data-capture node.

16. The network of claim 11 wherein the algorithm the server node is configured to perform further includes:
(a) identify an additional data-capture node; and
(b) access at least one of the group consisting of audio from the additional data-capture node and video data from the additional data-capture node.

17. The network of claim 11 wherein the algorithm the server node is configured to perform further includes:
(a) identify a communication node; and
(b) transmit, to the communication node, an indication of the emergency event.

18. The network of claim 11 wherein the algorithm the server node is configured to perform further includes:
(a) identify a communication node; and
(b) transmit, to the communication node, at least a portion of one or more of the group consisting of audio, video, and location data accessed from the first data-capture node.
